(19) United States
(12) Patent Application Publication
(10) Pub. No.: US 2022/0405648 A1
(43) Pub. Date: Dec. 22, 2022

(54) SYSTEM AND METHOD FOR PREPENDING ROBUSTIFIER FOR PRE-TRAINED MODELS AGAINST ADVERSARIAL ATTACKS

(71) Applicant: Robert Bosch GmbH, Stuttgart (DE)

(72) Inventors: Wan-Yi LIN, Wexford, PA (US); Leonid BOYTSOV, Pittsburgh, PA (US); Mohammad Sadegh NOROUZZADEH, Pittsburgh, PA (US); Jeremy KOLTER, Pittsburgh, PA (US); Filipe J. CABRITA CONDESSA, Pittsburgh, PA (US)

(21) Appl. No.: 17/349,645

(22) Filed: Jun. 16, 2021

(51) Int. Cl. G06N 20/20; G06N 3/04; G06N 3/08; G06K 9/62

(52) U.S. Cl. CPC G06N 20/20; G06N 3/04; G06N 3/08; G06K 9/6256; G06K 9/6262

(57) ABSTRACT

A computer-implemented method for training a machine-learning network. The method includes receiving an input data from a sensor, wherein the input data is indicative of image, radar, sonar, or sound information, generating an input data set utilizing the input data, wherein the input data set includes perturbed data, sending the input data set to a robustifier, wherein the robustifier is configured to clean the input data set by removing perturbations associated with the input data set to create a modified input data set, sending the modified input data set to a pretrained machine learning task, training the robustifier to obtain a trained robustifier utilizing the modified input data set, and in response to convergence of the trained robustifier to a first threshold, output the trained robustifier.

### GOVERNMENT RIGHTS

At least one or more portions of this invention may have been made with government support under U.S. Government Contract No. 1190060-430433 awarded by Defense Advanced Research Projects Agency (DARPA). The U.S. Government may therefore have certain rights in this invention.

### TECHNICAL FIELD

The present disclosure relates to augmentation and processing of an image (or other inputs) utilizing machine learning.

### BACKGROUND

While deep neural networks continue to display incredible performance in domains including computer vision and natural language processing, they deep neural networks have been increasingly shown to be lacking robustness.

Equipping an AI system to be robust to perturbations to its expected input (e.g. adversarial perturbations, natural perturbations) comes at a cost of reduced performance on its expected input (clean performance). The system may define expected input as the set and/or distribution of inputs on which the classifier is expected to operate (e.g. an AI system trained to operate in daylight in highway operating in daylight conditions in a highway)—the system may name the measured performance of the AI in this task as clean performance. Perturbations to the expected input can come from multiple sources, from which the system can highlight adversarial (e.g. perturbations to the input coming from an adversarial source that might have full access to the information about the classifier architecture and internal parameters), and natural (e.g. perturbations to the input coming from a natural source that could have been unaccounted for during the process of design and training the AI system such as sun glares, snow, fog, or other natural occurring conditions that would affect the distribution of inputs). The set of perturbations being considered for training and/or evaluation is denoted as perturbation set or threat model.

An AI system can be equipped to be robust to perturbations (hereby robustified) from two different ways: 1) robust training of the AI system/empirical robustness—on which the AI system is trained on a mixture of original (unperturbed/expected) input and of perturbed input (by a variety of types of perturbed inputs); 2) certified robustness—on which the behavior of the AI system is bounded to provide the same outputs to all possible input variations within the perturbation set. Furthermore, if a pre-trained AI system exists, robustification can be achieved by: 1) re-training the entire system to be robust (by empirical or certifiable robustness; or 2) retraining existing portions (instead of the entirety) of the AI system or by training and/or adding extra components that sanitize the input and/or the output.

Many systems focus on certified robustness. One of the methods that make a pretrained model robust is to make multiple copies of the input data, add random noise on to each copy of the data, run each copy through a denoiser and then the model, and finally use the majority of the output as the robust output. However, robustness may be bounded theoretically, and the architecture of prepended robust layers may be restricted to an image denoiser and adding random noise. This may restrict the empirical robustness of the system. In addition, this may require making multiple predictions of one input, making it slow at test time. Due to the majority vote mechanism, this may only be applicable to classification. In addition, such a method may be used only to defend against digital attack, especially l2-norm bounded attack and totally fail for physically realizable attack and much degraded performance for other norm bounded attack.

### SUMMARY

A first embodiment discloses, a computer-implemented method for training a machine-learning network. The method includes receiving an input data from a sensor, wherein the input data is indicative of image, radar, sonar, or sound information, generating an input data set utilizing the input data, wherein the input data set includes perturbed data, sending the input data set to a robustifier, wherein the robustifier is configured to clean the input data set by removing perturbations associated with the input data set to create a modified input data set, sending the modified input data set to a pretrained machine learning task, training the robustifier to obtain a trained robustifier utilizing the modified input data set, and in response to convergence of the trained robustifier to a first threshold, output the trained robustifier.

A second embodiment discloses, a computer-program product storing instructions which, when executed by a computer, cause the computer to receive an input data from a sensor, wherein the sensor includes a camera, a radar, a sonar, or a microphone, generate an input data set utilizing the input data set, wherein the input data set includes perturbed data, send the input data set to a robustifier, wherein the robustifier is configured to clean the input data set by removing perturbations associated with the input data set to create a modified input data set, send the modified input data set to a pretrained machine learning task, train the robustifier utilizing the modified input data set, and output a trained robustifier upon convergence to a first threshold.

A third embodiment discloses a system that includes a machine-learning network. The system includes an input interface configured to receive input data from a sensor, wherein the sensor includes a camera, a radar, a sonar, or a microphone. The system includes a processor, in communication with the input interface, wherein the processor is programmed to receive the input data, wherein the input data is indicative of image, radar, sonar, or sound information, generate an input data set utilizing the input data, wherein the input data set includes perturbed data, send the input data set to a robustifier, wherein the robustifier is configured to clean the input data set by removing perturbations associated with the input data set to create a modified input data set, send the modified input data set to a machine learning task, train the robustifier utilizing the modified input data set to obtain a trained robustifier, and output the trained robustifier and the machine learning task in response to convergence to a first threshold.

### BRIEF DESCRIPTION OF THE DRAWINGS

FIG. 1 shows a system 100 for training a neural network.

FIG. 2 shows a computer-implemented method 200 for training a neural network.

FIG. 3 depicts a data annotation system 300 to implement a system for annotating data.

FIG. 4 is an exemplary flow chart of a system training a neural network to learn perturbation data sets and jointly train a generator and classifier.

FIG. 5 depicts a schematic diagram of an interaction between computer-controlled machine 10 and control system 12.

FIG. 6 depicts a schematic diagram of the control system of FIG. 1 configured to control a vehicle, which may be a partially autonomous vehicle or a partially autonomous robot.

FIG. 7 depicts a schematic diagram of the control system of FIG. 1 configured to control a manufacturing machine, such as a punch cutter, a cutter or a gun drill, of manufacturing system, such as part of a production line.

FIG. 8 depicts a schematic diagram of the control system of FIG. 1 configured to control a power tool, such as a power drill or driver, that has an at least partially autonomous mode.

FIG. 9 depicts a schematic diagram of the control system of FIG. 1 configured to control an automated personal assistant.

FIG. 10 depicts a schematic diagram of the control system of FIG. 1 configured to control a monitoring system, such as a control access system or a surveillance system.

FIG. 11 depicts a schematic diagram of the control system of FIG. 1 configured to control an imaging system, for example an MM apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Most pre-trained classifiers, though they may work extremely well on the domain they were trained upon, are not trained in a robust fashion, and therefore are susceptible to adversarial attacks. A recent technique, denoised-smoothing, demonstrated that it was possible to create certifiably robust classifiers from a pre-trained classifier (without any retraining) by pre-pending a denoising network and wrapping the entire pipeline within randomized smoothing. However, this is a costly procedure, which requires multiple queries due to the randomized smoothing element, and which ultimately is very dependent on the quality of the denoiser. The embodiments below demonstrate that a more conventional adversarial training approach also works when applied to a robustification process. Specifically, by training an image-to-image translation model, prepended to a pre-trained classifier, with losses that optimize for both the fidelity of the image reconstruction and the adversarial performance of the end-to-end system, the system can robustify pre-trained classifiers to a higher empirical degree of accuracy than denoised smoothing, while being more efficient at inference time. Furthermore, these robustifiers are also transferable to some degree across multiple classifiers and even some architectures, illustrating that in some real sense they are removing the “adversarial manifold” from the input data, a task that has traditionally been very challenging for “conventional” preprocessing methods.

Thus the embodiments disclosed below propose an “empirical robustness” analogue of these methods for robustifying pre-trained models, demonstrating an efficient yet powerful method to make a pre-trained classifier robust to adversarial attacks without re-optimizing any of its parameters. The system may prepend an image-to-image translation model (e.g., robustifier) in front of the pretrained model. Unlike other models, the system may train the robustifier so as to optimize the adversarial performance of the entire end-to-end pipeline (e.g., the combination of the robustifier and the pretrained model), by only modifying the parameters of the robustifier itself, and leaving the parameters of the pre-trained model frozen. Additionally, the system may penalize (1) the adversarial loss of the end-to-end system (e.g., to ensure that the robustifier doesn't destroy the image content0, (2) the difference between input and outputs of the robustifier (to ensure that the robustifier doesn't destroy the image content); and (3) the difference in activations between original and adversarial images in the pretrained classifier (this may enforce that the post-robustified image should “look like” the non-adversarial image as much as possible to the classifier.

Such an embodiment may eliminate the need for multiple queries per sample but may also provide better results than denoised smoothing. The approach may also in theory be applied to any setting where adversarial training can be used, rather than applying only to classification settings. This can be transferred among different models and even different architectures. The transferability results indicate that a preprocessor model can, to some extent, learn to separate the “adversarial manifold” from the input data, a key challenging task for “conventional” preprocessing methods.

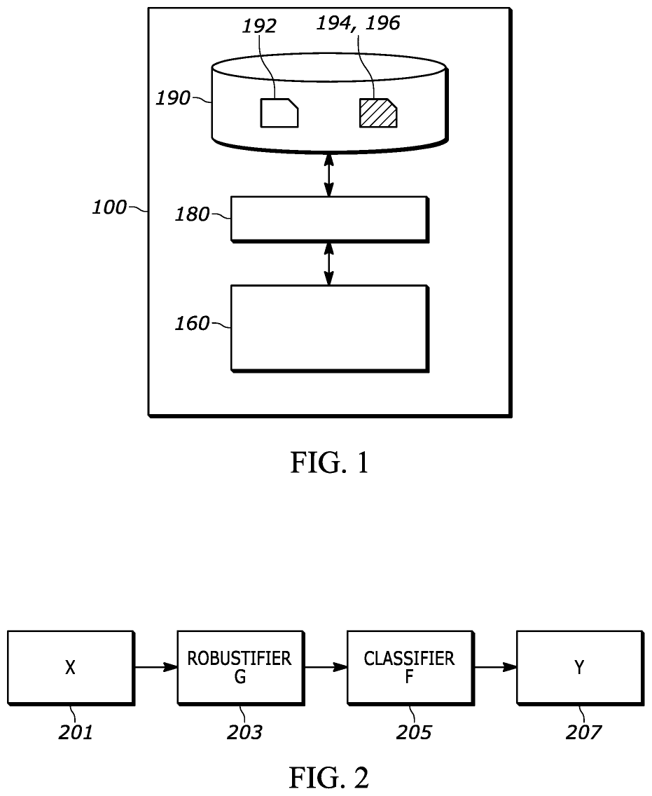

FIG. 1 shows a system 100 for training a neural network. The system 100 may comprise an input interface for accessing training data 192 for the neural network. For example, as illustrated in FIG. 1, the input interface may be constituted by a data storage interface 180 which may access the training data 192 from a data storage 190. For example, the data storage interface 180 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 190 may be an internal data storage of the system 100, such as a hard drive or SSD, but also an external data storage, e.g., a network-accessible data storage.

In some embodiments, the data storage 190 may further comprise a data representation 194 of an untrained version of the neural network which may be accessed by the system 100 from the data storage 190. It will be appreciated, however, that the training data 192 and the data representation 194 of the untrained neural network may also each be accessed from a different data storage, e.g., via a different subsystem of the data storage interface 180. Each subsystem may be of a type as is described above for the data storage interface 180. In other embodiments, the data representation 194 of the untrained neural network may be internally generated by the system 100 on the basis of design parameters for the neural network, and therefore may not explicitly be stored on the data storage 190. The system 100 may further comprise a processor subsystem 160 which may be configured to, during operation of the system 100, provide an iterative function as a substitute for a stack of layers of the neural network to be trained. In one embodiment, respective layers of the stack of layers being substituted may have mutually shared weights and may receive, as input, an output of a previous layer, or for a first layer of the stack of layers, an initial activation, and a part of the input of the stack of layers. The system may also include multiple layers. The processor subsystem 160 may be further configured to iteratively train the neural network using the training data 192. Here, an iteration of the training by the processor subsystem 160 may comprise a forward propagation part and a backward propagation part. The processor subsystem 160 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 196 of the trained neural network, this data may also be referred to as trained model data 196. For example, as also illustrated in FIG. 1, the output interface may be constituted by the data storage interface 180, with said interface being in these embodiments an input/output (“IO”) interface, via which the trained model data 196 may be stored in the data storage 190. For example, the data representation 194 defining the ‘untrained’ neural network may during or after the training be replaced, at least in part by the data representation 196 of the trained neural network, in that the parameters of the neural network, such as weights, hyper parameters and other types of parameters of neural networks, may be adapted to reflect the training on the training data 192. This is also illustrated in FIG. 1 by the reference numerals 194, 196 referring to the same data record on the data storage 190. In other embodiments, the data representation 196 may be stored separately from the data representation 194 defining the ‘untrained’ neural network. In some embodiments, the output interface may be separate from the data storage interface 180, but may in general be of a type as described above for the data storage interface 180.

FIG. 2 is a diagram of a machine learning network that includes a robustifier and a classifier 205. The system may receive an input 201 that is fed into a robustifier 203. The robustifier 203 may be a pretrained robustifier g that is fed the input x. The robustifier may output a modified version of the input with the perturbation removed. The input 201 may include an image, sound, video, or other type of images. The robustifier 203 may also send the modified data to a classifier 205. The classifier 205 is simply one example of a machine learning task, but any type of machine learning task may be utilized. This may include object detection, speech recognition, semantic segmentation, etc. The output (y) 207 may be correlated to the classifier 205 or the other type of machine learning task. Thus, the output (y) 207 may be a classification of the input, a detection of the object, the speech recognized, etc.

According to FIG. 2, both clean and perturbed versions of each batch may be fed to the robustifier model and consequently the classifier, which may be a pre-trained classifier. The loss function may include the cross-entropy loss, mean-square-error (MSE) between the input images and output of robustifier for perturbed images, and MSE loss between activation values at different selected layers of the pre-trained classifier for the outputs of the robustifier. Loss value may be calculated as well.

FIG. 2 may show at a high-level the details the use of the robustifier within a machine learning system that performs a classification task. In this scenario, the input data x is fed into a pretrained robustifier g. This robustifier received as input x and outputs a modified version of the input with the perturbation removed x′<−g(x). This modified version of the input is then fed into the classifier resulting on a robust classification y. The pre-pended robustifier may make a pre-trained machine learning model robust against adversarial attacks. The proposed method may only require one forward pass and can be directly applied to tasks beyond classification, such as object detection, semantic segmentation, or speech recognition. Any image-to-image architecture could be utilized as a robustifier, such as a Variational Autoenecoder (VAEs), image denoisers, or semantic segmentation networks (e.g., U-Net style architecture).

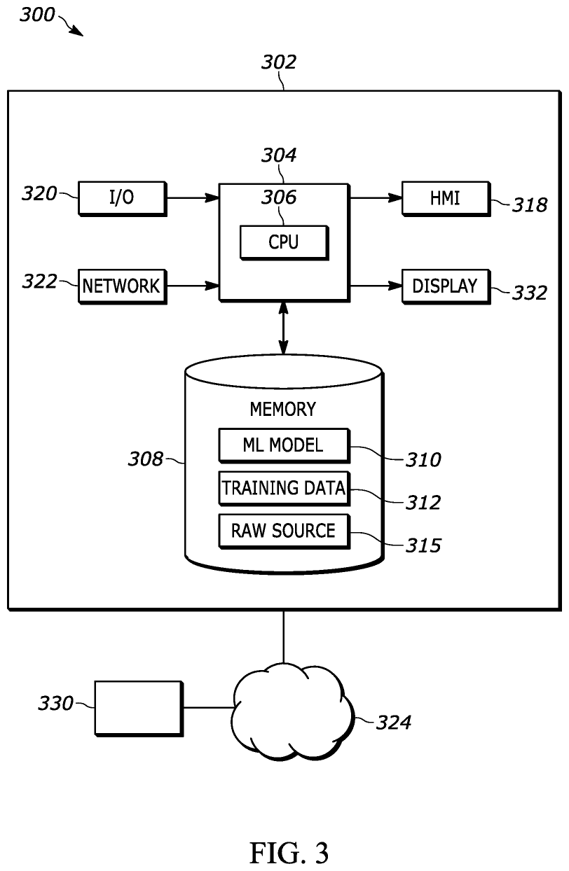

FIG. 3 depicts a data annotation system 300 to implement a system for annotating data. The data annotation system 300 may include at least one computing system 302. The computing system 302 may include at least one processor 304 that is operatively connected to a memory unit 308. The processor 304 may include one or more integrated circuits that implement the functionality of a central processing unit (CPU) 306. The CPU 306 may be a commercially available processing unit that implements an instruction stet such as one of the x86, ARM, Power, or MIPS instruction set families. During operation, the CPU 306 may execute stored program instructions that are retrieved from the memory unit 308. The stored program instructions may include software that controls operation of the CPU 306 to perform the operation described herein. In some examples, the processor 304 may be a system on a chip (SoC) that integrates functionality of the CPU 306, the memory unit 308, a network interface, and input/output interfaces into a single integrated device. The computing system 302 may implement an operating system for managing various aspects of the operation.

The memory unit 308 may include volatile memory and non-volatile memory for storing instructions and data. The non-volatile memory may include solid-state memories, such as NAND flash memory, magnetic and optical storage media, or any other suitable data storage device that retains data when the computing system 302 is deactivated or loses electrical power. The volatile memory may include static and dynamic random-access memory (RAM) that stores program instructions and data. For example, the memory unit 308 may store a machine-learning model 310 or algorithm, a training dataset 312 for the machine-learning model 310, raw source dataset 315.

The computing system 302 may include a network interface device 322 that is configured to provide communication with external systems and devices. For example, the network interface device 322 may include a wired and/or wireless Ethernet interface as defined by Institute of Electrical and Electronics Engineers (IEEE) 802.11 family of standards. The network interface device 322 may include a cellular communication interface for communicating with a cellular network (e.g., 3G, 4G, 5G). The network interface device 322 may be further configured to provide a communication interface to an external network 324 or cloud.

The external network 324 may be referred to as the world-wide web or the Internet. The external network 324 may establish a standard communication protocol between computing devices. The external network 324 may allow information and data to be easily exchanged between computing devices and networks. One or more servers 330 may be in communication with the external network 324.

The computing system 302 may include an input/output (I/O) interface 320 that may be configured to provide digital and/or analog inputs and outputs. The I/O interface 320 may include additional serial interfaces for communicating with external devices (e.g., Universal Serial Bus (USB) interface).

The computing system 302 may include a human-machine interface (HMI) device 318 that may include any device that enables the system 300 to receive control input. Examples of input devices may include human interface inputs such as keyboards, mice, touchscreens, voice input devices, and other similar devices. The computing system 302 may include a display device 332. The computing system 302 may include hardware and software for outputting graphics and text information to the display device 332. The display device 332 may include an electronic display screen, projector, printer or other suitable device for displaying information to a user or operator. The computing system 302 may be further configured to allow interaction with remote HMI and remote display devices via the network interface device 322.

The system 300 may be implemented using one or multiple computing systems. While the example depicts a single computing system 302 that implements all of the described features, it is intended that various features and functions may be separated and implemented by multiple computing units in communication with one another. The particular system architecture selected may depend on a variety of factors.

The system 300 may implement a machine-learning algorithm 310 that is configured to analyze the raw source dataset 315. The raw source dataset 315 may include raw or unprocessed sensor data that may be representative of an input dataset for a machine-learning system. The raw source dataset 315 may include video, video segments, images, text-based information, and raw or partially processed sensor data (e.g., radar map of objects). In some examples, the machine-learning algorithm 310 may be a neural network algorithm that is designed to perform a predetermined function. For example, the neural network algorithm may be configured in automotive applications to identify pedestrians in video images.

The computer system 300 may store a training dataset 312 for the machine-learning algorithm 310. The training dataset 312 may represent a set of previously constructed data for training the machine-learning algorithm 310. The training dataset 312 may be used by the machine-learning algorithm 310 to learn weighting factors associated with a neural network algorithm. The training dataset 312 may include a set of source data that has corresponding outcomes or results that the machine-learning algorithm 310 tries to duplicate via the learning process. In this example, the training dataset 312 may include source videos with and without pedestrians and corresponding presence and location information. The source videos may include various scenarios in which pedestrians are identified.

The machine-learning algorithm 310 may be operated in a learning mode using the training dataset 312 as input. The machine-learning algorithm 310 may be executed over a number of iterations using the data from the training dataset 312. With each iteration, the machine-learning algorithm 310 may update internal weighting factors based on the achieved results. For example, the machine-learning algorithm 310 can compare output results (e.g., annotations) with those included in the training dataset 312. Since the training dataset 312 includes the expected results, the machine-learning algorithm 310 can determine when performance is acceptable. After the machine-learning algorithm 310 achieves a predetermined performance level (e.g., 100% agreement with the outcomes associated with the training dataset 312), the machine-learning algorithm 310 may be executed using data that is not in the training dataset 312. The trained machine-learning algorithm 310 may be applied to new datasets to generate annotated data.

The machine-learning algorithm 310 may be configured to identify a particular feature in the raw source data 315. The raw source data 315 may include a plurality of instances or input dataset for which annotation results are desired. For example, the machine-learning algorithm 310 may be configured to identify the presence of a pedestrian in video images and annotate the occurrences. The machine-learning algorithm 310 may be programmed to process the raw source data 315 to identify the presence of the particular features. The machine-learning algorithm 310 may be configured to identify a feature in the raw source data 315 as a predetermined feature (e.g., pedestrian). The raw source data 315 may be derived from a variety of sources. For example, the raw source data 315 may be actual input data collected by a machine-learning system. The raw source data 315 may be machine generated for testing the system. As an example, the raw source data 315 may include raw video images from a camera.

In the example, the machine-learning algorithm 310 may process raw source data 315 and output an indication of a representation of an image. The output may also include augmented representation of the image. A machine-learning algorithm 310 may generate a confidence level or factor for each output generated. For example, a confidence value that exceeds a predetermined high-confidence threshold may indicate that the machine-learning algorithm 310 is confident that the identified feature corresponds to the particular feature. A confidence value that is less than a low-confidence threshold may indicate that the machine-learning algorithm 310 has some uncertainty that the particular feature is present.

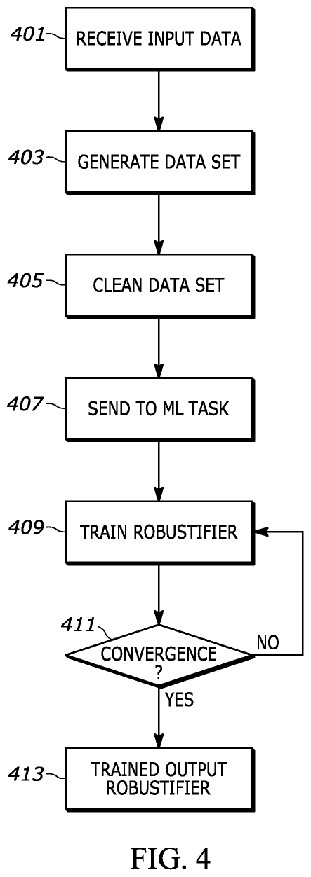

FIG. 4 is a flow chart illustrating a training of a robustifier according to an embodiment below. At step 401, the system may receive input data from one or more sensors. The sensors may be a camera, radar, x-ray, sonar, scanner, microphone, or similar sensor. The input data may include images, sound, or other information.

At step 403, the system may generate a data set. The data set may include an original data set and a perturbed version of the data set. The system may apply adversarial training via projected gradient descent (PGD) to composed system of a robustifier and the classifier in order to train the robustifier. The system may sample a minibatch (x, y) from the dataset, and then duplicate the minibatch, and then adversarially perturb one of the copies using PGD to get \tilde{x} (e.g., perturbed version of input).

At step 405, the system may then clean the data set utilizing the robustifier. Given a fixed pre-trained classifier h: χ→Y (we no longer write h as dependent on parameters θ, the system may treat h as fixed throughout), the system may prepend an image to image translation system referred to as the robustifier. A robustifier may be a network rθ:: χ→χ, parameterized by parameters θ such that a final prediction may be given by the composition of the classifier and robustifier h(rθ(x)). Generally speaking, any image-to-image architecture could be used as the robustifier, such as Variational Autoencoders (VAEs), image denoisers, or semantic segmentation networks (we will ultimately use a U-Net style architecture for this task).

The system may clean the data set to remove any perturbations associated with the input. The system may utilize the robustifier to clean the data set. The system may feed both the input data and perturbed data, x and \tilde{x}, to the robustifier and respectively feed the outputs of the robustifier, rθ(x) and rθ(\tilde{x}), to the pre-trained classifier h. The system may store rθ(x) and rθ(\tilde{x}), the final output of the pre-trained classifier for the perturbed image, h(rθ(\tilde{x})), as well as activations of selected intermediate layers during the forward path, h_{α}(x) and h_{α}(rθ(\tilde{x})). Finally the system may compute the losses accordingly and back-propagate the error.

At step 407, the system may send the clean data to the machine learning task. For example, the robustifier may send the modified data to a classifier. The classifier may simply one example of a machine learning task, but any type of machine learning task may be utilized. This may include object detection, speech recognition, semantic segmentation, etc.

At step 409, the system may train the robustifier. To train the robustifier, the system may apply adversarial training via projected gradient descent (PGD) to composed system of the robustifier and the classifier. That is, we could perform adversarial training on the objective

$${min}_{θ} = {E}_{x , y \sim 𝒟} [ {max}_{δ ∈ Δ} ℓ ( h ( r θ ( x + δ ) ) , y ) ] .$$

where [symbol] is the cross entropy loss, and Δ is the perturbation model. A difference between this and adversarial training is that the weights of the classifier itself may be fixed, and the system may only be using the parameters of the robustifier.

However, if the system is to train the robustifier with this objective, without any constraints on the output of the image-to-image network, the output images can diverge too far from the original images. Effectively, because the robustifier can learn to output any image into the classifier, the robustifier can effectively identify any low-dimensional manifold of the desired output itself, and simply output images in this reduced manifold. This may raise the possibility that the robustifier could simply “duplicate” the effort of a typical robust classifier, rather than actual “filtering” away any aspects of the adversarial perturbation in a generic manner.

To avoid this phenomenon, the system may additionally need to ensure some measure of fidelity to the original image. The system may do this by incorporating some form of reconstruction loss in our training objective, such as the Mean Squared Error (MSE) loss. The system may let \tilde{x} denote the adversarial perturbation of x according to the maximization above. The MSE loss may be written as:

[symbol]

^{mse}(x,\tilde{x})=∥x−rθ(\tilde{x})∥₂²

To further improve in this regard, it may be beneficial to penalize an MSE loss between intermediate layer activations of the pre-trained classifier applied to the original image, and these intermediate layer activations when applied to the output of the robustifier (applied to the adversarial example). That is, the system may want the output of the robustifier, when applied to an adversarial image, to produce an image that is “nearby” the original image, both in terms of the MSE on the original image and in terms of the activations produced by the pretrained classifier. Letting h_{α} denote the activations of classifier h at selected intermediate layers L, this corresponds to the loss

[symbol]

^{act}(x,\tilde{x})=∥h_{α}(x)−h_{α}(rθ(\tilde{x}))∥₂²

Altogether, our training objective is the following:

α [symbol] (h(rθ(\tilde{x})),y)+β [symbol] ^{mse}(x,\tilde{x})+γ [symbol] ^{act}(x,\tilde{x})

where the coefficients α, β, and γ adjust the scale and relative importance of the loss terms. It is important to emphasize that while the system may include all three loss terms in training the robustifier, the adversarial attack itself does not directly try to maximize this combined loss, but just maximizes the original robust loss. This may be important, as the “strongest” adversary (and our eventual evaluation metric) is concerned solely with maximizing the adversarial loss; the other two components are effectively regularization terms, that prevent the robustifier model from overfitting to the min-max objective.

Adversarial examples generated for one model can also be effective on another model trained with different initialization, or even models with different architectures. This is commonly referred to as transferability of adversarial examples. Adversarial examples transfer well between commonly used image classifiers architectures, such as ResNet, DenseNet, VGG and Inception. The transferability of adversarial examples indicates that the adversarial manifold of different model architectures are closely related, thus if the system can remove adversarial noise on one model using robustifier, it is likely to be effective on models trained with different initialization, as well as other similar model architectures.

At step 411, the system may determine if convergence is being met or approached. The system may repeat until loss of f′ converges or a pre-defined stopping condition is reached. Thus, the network may establish a threshold for the pre-defined stopping condition based upon a certain value deemed to meet convergence and thus having a trained system. For example, a percentage or other score may be utilized as a threshold. However, if the system does not become trained, the system may continue to attempt to clean the data set 405.

At step 413, the system may output the trained robustifier. After training, the resulting model g (denoted as robustifier) will operate as a data-driven filter that removes perturbations from input. Thus, the robustifier can be applied as a filtering system that is prepended to the machine learning model. If the system does not reach or approach convergence, it may continue to train the robustifier to clean the perturbations from the input. To improve transferability of robustifier, the system may train the robustifier with an ensemble of M classifier (e.g., 20 ResNet-18 models trained using different initializations, or a few classifiers with different model architectures). To avoid the cost of forward and backward propagation on M base classifiers, the system may just randomly sample one base classifier each time rather than adding the prediction of all M classifiers together, according to one embodiment. This may allow the system to train the robustifier using an ensemble of base classifiers, while keeping the training cost similar to the case of training with 1 base model.

It should be noted that FIG. 4 discloses a representative flow chart of robustifying a machine learning network. This proposed method is an empirical data-driven method. The proposed method may solve a problem of robustifying an AI system/machine learning model f given a loss function L and a set of allowable perturbations Δ. The problem of robustifying a machine learning model is such that for an additive perturbation δ∈Δ the output the machine learning system on the perturbed input f(x+δ) does not differ from the output of the machine learning system on the original input f(x). Conversely, the perturbation δ∈Δ is designed such that

$$δ = arg {max}_{{δ}^{′} ∈ Δ} L ( f ; x + {δ}^{′} )$$

(i.e., formula (1), i.e. the perturbation is designed to maximize its effect (negative effect—by maximizing the loss function) on the machine learning system f by finding a solution (or approximate solution) to the optimization problem described in formula (1).

The problem of robustifying or defending the machine learning model f from adversarial perturbations is such that the model (or parts of it, or additional components) is parameterized or reparameterized such that its performance is optimized for the set of perturbations (or worst case perturbations found by formula (1)) taking in account the classifier f, perturbation space A, loss function L and input x. To defend the machine learning model f as described above, the proposed method is to add a dense prediction model g characterized by parameter set 0 before f, which may be the new model:

f′=f(g(θ,x)), (2)

Where the model g (which maps the input into an intermediate input of the same dimensions of the original input that will be fed into the model f) can be any dense prediction network, such as semantic segmentation networks (FCN, Unet, DAnet, Deeplab), image denoiser (dncnn), and variational autoencoder.

The following steps may be used to train g with a set of unperturbed training data t {x|x∈X}, and a set of allowable perturbations Δ:

Given a batch of input t {x|x∈X}, generate a perturbation δ for each input in the batch based on formula (1) on the composite model f′=f(g)

Update g's parameter by minimizing the loss function of the composite model with ∇L(f(g(x+δ))), this update can be done using existing optimizers, such as SGD, adam, etc.

The system may repeat until loss of f′ converges or a pre-defined stopping condition is reached. Thus, the network may establish a threshold for the pre-defined stopping condition based upon a certain value deemed to meet convergence and thus having a trained system. For example, a percentage or other score may be utilized as a threshold.

After training, the resulting model g (denoted as robustifier) will operate as a data-driven filter that removes perturbations from input. Thus, the robustifier can be applied as a filtering system that is prepended to the machine learning model. Furthermore, the method can be applied to different sets of allowable perturbations, obtaining different robustifiers. Different robustifiers (robust to different perturbation models) can then be combined or interchanged (either manually by an operator, or automatically by a control signal provided by a secondary algorithm that can detect the threat model) providing higher levels of robustness and model defense to multiple or unknown threat models without significant performance trade-offs. Furthermore, additional components of the loss function can be added to impose further constraints on the robustifier training (e.g. minimize perceptual distortion between robustifier's input and output).

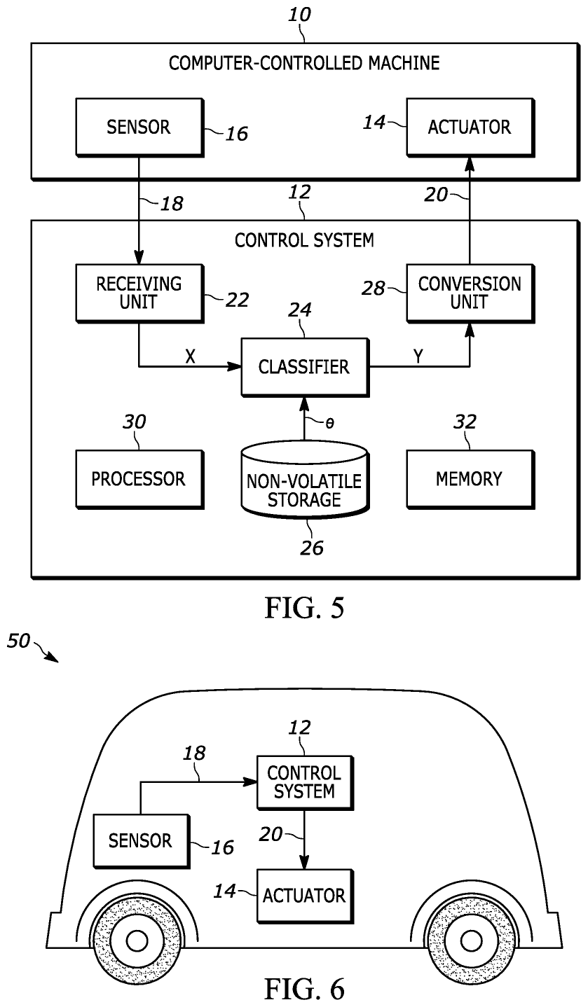

FIG. 5 depicts a schematic diagram of an interaction between computer-controlled machine 10 and control system 12. The computer-controlled machine 10 may include a neural network as described in FIGS. 1-4. The computer-controlled machine 10 includes actuator 14 and sensor 16. Actuator 14 may include one or more actuators and sensor 16 may include one or more sensors. Sensor 16 is configured to sense a condition of computer-controlled machine 10. Sensor 16 may be configured to encode the sensed condition into sensor signals 18 and to transmit sensor signals 18 to control system 12. Non-limiting examples of sensor 16 include video, radar, LiDAR, ultrasonic and motion sensors. In one embodiment, sensor 16 is an optical sensor configured to sense optical images of an environment proximate to computer-controlled machine 10.

Control system 12 is configured to receive sensor signals 18 from computer-controlled machine 10. As set forth below, control system 12 may be further configured to compute actuator control commands 20 depending on the sensor signals and to transmit actuator control commands 20 to actuator 14 of computer-controlled machine 10.

As shown in FIG. 5, control system 12 includes receiving unit 22. Receiving unit 22 may be configured to receive sensor signals 18 from sensor 16 and to transform sensor signals 18 into input signals x. In an alternative embodiment, sensor signals 18 are received directly as input signals x without receiving unit 22. Each input signal x may be a portion of each sensor signal 18. Receiving unit 22 may be configured to process each sensor signal 18 to product each input signal x. Input signal x may include data corresponding to an image recorded by sensor 16.

Control system 12 includes classifier 24. Classifier 24 may be configured to classify input signals x into one or more labels using a machine learning (ML) algorithm, such as a neural network described above. Classifier 24 is configured to be parametrized by parameters, such as those described above (e.g., parameter θ). Parameters θ may be stored in and provided by non-volatile storage 26. Classifier 24 is configured to determine output signals y from input signals x. Each output signal y includes information that assigns one or more labels to each input signal x. Classifier 24 may transmit output signals y to conversion unit 28. Conversion unit 28 is configured to covert output signals y into actuator control commands 20. Control system 12 is configured to transmit actuator control commands 20 to actuator 14, which is configured to actuate computer-controlled machine 10 in response to actuator control commands 20. In another embodiment, actuator 14 is configured to actuate computer-controlled machine 10 based directly on output signals y.

Upon receipt of actuator control commands 20 by actuator 14, actuator 14 is configured to execute an action corresponding to the related actuator control command 20. Actuator 14 may include a control logic configured to transform actuator control commands 20 into a second actuator control command, which is utilized to control actuator 14. In one or more embodiments, actuator control commands 20 may be utilized to control a display instead of or in addition to an actuator.

In another embodiment, control system 12 includes sensor 16 instead of or in addition to computer-controlled machine 10 including sensor 16. Control system 12 may also include actuator 14 instead of or in addition to computer-controlled machine 10 including actuator 14.

As shown in FIG. 5, control system 12 also includes processor 30 and memory 32. Processor 30 may include one or more processors. Memory 32 may include one or more memory devices. The classifier 24 (e.g., ML algorithms) of one or more embodiments may be implemented by control system 12, which includes non-volatile storage 26, processor 30 and memory 32.

Non-volatile storage 26 may include one or more persistent data storage devices such as a hard drive, optical drive, tape drive, non-volatile solid-state device, cloud storage or any other device capable of persistently storing information. Processor 30 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 32. Memory 32 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 30 may be configured to read into memory 32 and execute computer-executable instructions residing in non-volatile storage 26 and embodying one or more ML algorithms and/or methodologies of one or more embodiments. Non-volatile storage 26 may include one or more operating systems and applications. Non-volatile storage 26 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 30, the computer-executable instructions of non-volatile storage 26 may cause control system 12 to implement one or more of the ML algorithms and/or methodologies as disclosed herein. Non-volatile storage 26 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 12 configured to control vehicle 50, which may be an at least partially autonomous vehicle or an at least partially autonomous robot. As shown in FIG. 5, vehicle 50 includes actuator 14 and sensor 16. Sensor 16 may include one or more video sensors, radar sensors, ultrasonic sensors, LiDAR sensors, and/or position sensors (e.g. GPS). One or more of the one or more specific sensors may be integrated into vehicle 50. Alternatively or in addition to one or more specific sensors identified above, sensor 16 may include a software module configured to, upon execution, determine a state of actuator 14. One non-limiting example of a software module includes a weather information software module configured to determine a present or future state of the weather proximate vehicle 50 or other location.

Classifier 24 of control system 12 of vehicle 50 may be configured to detect objects in the vicinity of vehicle 50 dependent on input signals x. In such an embodiment, output signal y may include information characterizing the vicinity of objects to vehicle 50. Actuator control command 20 may be determined in accordance with this information. The actuator control command 20 may be used to avoid collisions with the detected objects.

In embodiments where vehicle 50 is an at least partially autonomous vehicle, actuator 14 may be embodied in a brake, a propulsion system, an engine, a drivetrain, or a steering of vehicle 50. Actuator control commands 20 may be determined such that actuator 14 is controlled such that vehicle 50 avoids collisions with detected objects. Detected objects may also be classified according to what classifier 24 deems them most likely to be, such as pedestrians or trees. The actuator control commands 20 may be determined depending on the classification. The control system 12 may utilize the robustifier to help train the network for adversarial conditions, such as during poor lighting conditions or poor weather conditions of the vehicle environment, as well as an attack.

In other embodiments where vehicle 50 is an at least partially autonomous robot, vehicle 50 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 20 may be determined such that a propulsion unit, steering unit and/or brake unit of the mobile robot may be controlled such that the mobile robot may avoid collisions with identified objects.

In another embodiment, vehicle 50 is an at least partially autonomous robot in the form of a gardening robot. In such embodiment, vehicle 50 may use an optical sensor as sensor 16 to determine a state of plants in an environment proximate vehicle 50. Actuator 14 may be a nozzle configured to spray chemicals. Depending on an identified species and/or an identified state of the plants, actuator control command 20 may be determined to cause actuator 14 to spray the plants with a suitable quantity of suitable chemicals.

Vehicle 50 may be an at least partially autonomous robot in the form of a domestic appliance. Non-limiting examples of domestic appliances include a washing machine, a stove, an oven, a microwave, or a dishwasher. In such a vehicle 50, sensor 16 may be an optical sensor configured to detect a state of an object which is to undergo processing by the household appliance. For example, in the case of the domestic appliance being a washing machine, sensor 16 may detect a state of the laundry inside the washing machine. Actuator control command 20 may be determined based on the detected state of the laundry.

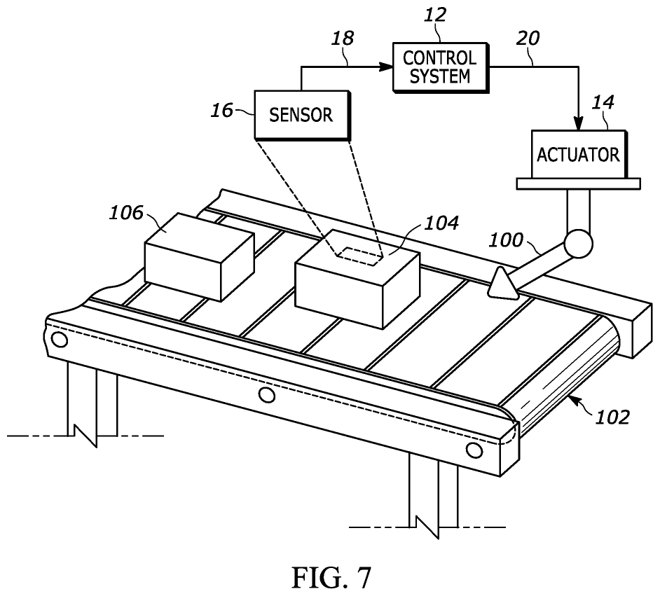

FIG. 7 depicts a schematic diagram of control system 12 configured to control system 100 (e.g., manufacturing machine), such as a punch cutter, a cutter or a gun drill, of manufacturing system 102, such as part of a production line. Control system 12 may be configured to control actuator 14, which is configured to control system 100 (e.g., manufacturing machine).

Sensor 16 of system 100 (e.g., manufacturing machine) may be an optical sensor configured to capture one or more properties of manufactured product 104. Classifier 24 may be configured to determine a state of manufactured product 104 from one or more of the captured properties. Actuator 14 may be configured to control system 100 (e.g., manufacturing machine) depending on the determined state of manufactured product 104 for a subsequent manufacturing step of manufactured product 104. The actuator 14 may be configured to control functions of system 100 (e.g., manufacturing machine) on subsequent manufactured product 106 of system 100 (e.g., manufacturing machine) depending on the determined state of manufactured product 104. The control system 12 may utilize the robustifier to help train the machine learning network for adversarial conditions, such as during poor lighting conditions or working conditions difficult for the sensors to identify conditions, such as lots of dust.

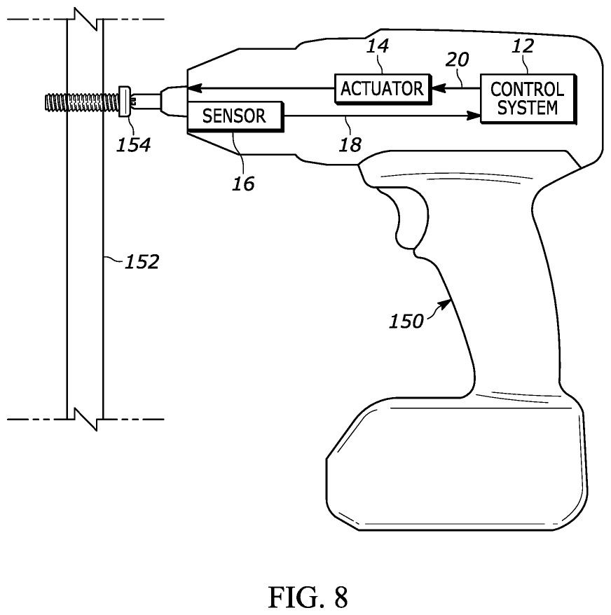

FIG. 8 depicts a schematic diagram of control system 12 configured to control power tool 150, such as a power drill or driver, that has an at least partially autonomous mode. Control system 12 may be configured to control actuator 14, which is configured to control power tool 150.

Sensor 16 of power tool 150 may be an optical sensor configured to capture one or more properties of work surface 152 and/or fastener 154 being driven into work surface 152. Classifier 24 may be configured to determine a state of work surface 152 and/or fastener 154 relative to work surface 152 from one or more of the captured properties. The state may be fastener 154 being flush with work surface 152. The state may alternatively be hardness of work surface 152. Actuator 14 may be configured to control power tool 150 such that the driving function of power tool 150 is adjusted depending on the determined state of fastener 154 relative to work surface 152 or one or more captured properties of work surface 152. For example, actuator 14 may discontinue the driving function if the state of fastener 154 is flush relative to work surface 152. As another non-limiting example, actuator 14 may apply additional or less torque depending on the hardness of work surface 152. The control system 12 may utilize the robustifier to help train the machine learning network for adversarial conditions, such as during poor lighting conditions or poor weather conditions. Thus, the control system 12 may be able to identify environment conditions of the power tool 150.

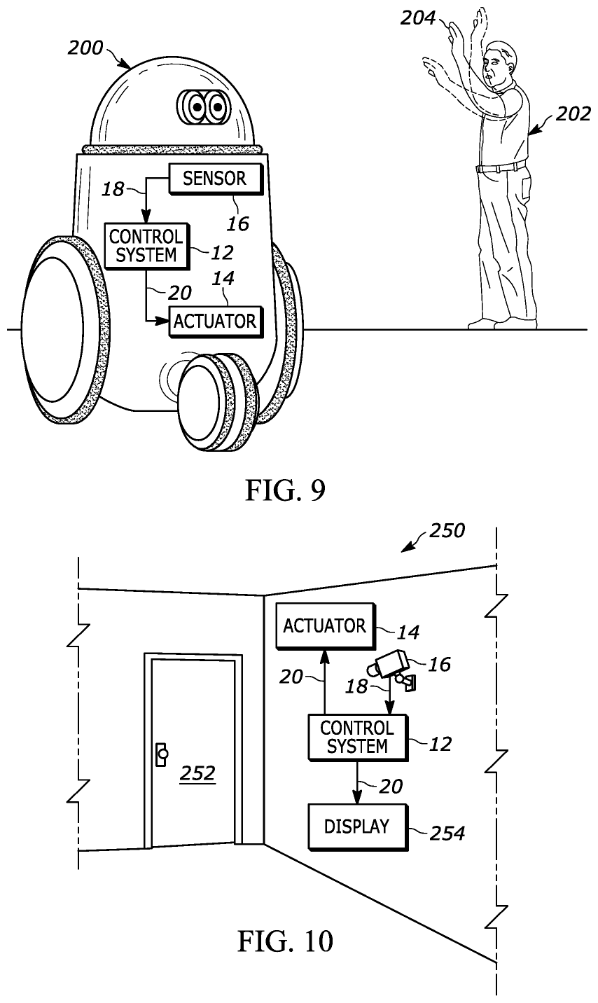

FIG. 9 depicts a schematic diagram of control system 12 configured to control automated personal assistant 900. Control system 12 may be configured to control actuator 14, which is configured to control automated personal assistant 900. Automated personal assistant 900 may be configured to control a domestic appliance, such as a washing machine, a stove, an oven, a microwave or a dishwasher.

Sensor 16 may be an optical sensor and/or an audio sensor. The optical sensor may be configured to receive video images of gestures 904 of user 902. The audio sensor may be configured to receive a voice command of user 902.

Control system 12 of automated personal assistant 900 may be configured to determine actuator control commands 20 configured to control system 12. Control system 12 may be configured to determine actuator control commands 20 in accordance with sensor signals 18 of sensor 16. Automated personal assistant 900 is configured to transmit sensor signals 18 to control system 12. Classifier 24 of control system 12 may be configured to execute a gesture recognition algorithm to identify gesture 904 made by user 902, to determine actuator control commands 20, and to transmit the actuator control commands 20 to actuator 14. Classifier 24 may be configured to retrieve information from non-volatile storage in response to gesture 904 and to output the retrieved information in a form suitable for reception by user 902. The control system 12 may utilize the robustifier to help train the machine learning network for adversarial conditions, such as during poor lighting conditions or poor weather conditions. Thus, the control system 12 may be able to identify gestures during such conditions.

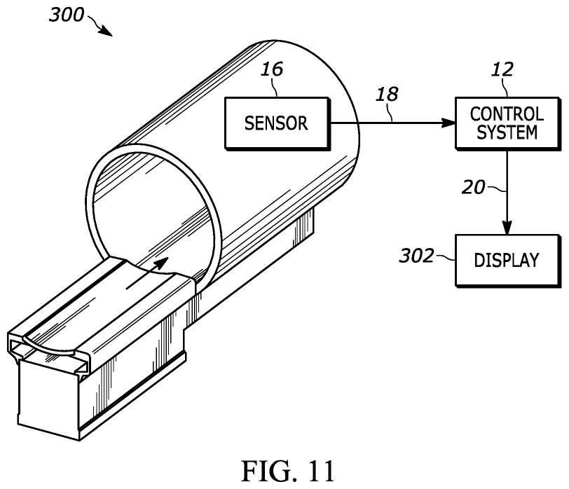

FIG. 10 depicts a schematic diagram of control system 12 configured to control monitoring system 250. Monitoring system 250 may be configured to physically control access through door 252. Sensor 16 may be configured to detect a scene that is relevant in deciding whether access is granted. Sensor 16 may be an optical sensor configured to generate and transmit image and/or video data. Such data may be used by control system 12 to detect a person's face. The control system 12 may utilize the robustifier to help train the machine learning network for adversarial conditions during poor lighting conditions or in the case of an intruder of an environment of the control monitoring system 250.

Classifier 24 of control system 12 of monitoring system 250 may be configured to interpret the image and/or video data by matching identities of known people stored in non-volatile storage 26, thereby determining an identity of a person. Classifier 24 may be configured to generate and an actuator control command 20 in response to the interpretation of the image and/or video data. Control system 12 is configured to transmit the actuator control command 20 to actuator 14. In this embodiment, actuator 14 may be configured to lock or unlock door 252 in response to the actuator control command 20. In other embodiments, a non-physical, logical access control is also possible.

Monitoring system 250 may also be a surveillance system. In such an embodiment, sensor 16 may be an optical sensor configured to detect a scene that is under surveillance and control system 12 is configured to control display 254. Classifier 24 is configured to determine a classification of a scene, e.g. whether the scene detected by sensor 16 is suspicious. Control system 12 is configured to transmit an actuator control command 20 to display 254 in response to the classification. Display 254 may be configured to adjust the displayed content in response to the actuator control command 20. For instance, display 254 may highlight an object that is deemed suspicious by classifier 24.

FIG. 11 depicts a schematic diagram of control system 12 configured to control imaging system 1100, for example an Mill apparatus, x-ray imaging apparatus or ultrasonic apparatus. Sensor 16 may, for example, be an imaging sensor. Classifier 24 may be configured to determine a classification of all or part of the sensed image. Classifier 24 may be configured to determine or select an actuator control command 20 in response to the classification obtained by the trained neural network. For example, classifier 24 may interpret a region of a sensed image to be potentially anomalous. In this case, actuator control command 20 may be determined or selected to cause display 302 to display the imaging and highlighting the potentially anomalous region. The control system 12 may utilize the robustifier to help train the machine learning network for adversarial conditions during an X-ray, such as poor lighting.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for training a machine-learning network, comprising:
receiving an input data from a sensor, wherein the input data is indicative of image, radar, sonar, or sound information;
generate an input data set utilizing the input data, wherein the input data set includes perturbed data;
send the input data set to a robustifier, wherein the robustifier is configured to clean the input data set by removing perturbations associated with the input data set to create a modified input data set;
send the modified input data set to a pretrained machine learning task;
training the robustifier to obtain a trained robustifier utilizing the modified input data set; and
in response to convergence of the trained robustifier to a first threshold, output the trained robustifier.

2. The computer-implemented method of claim 1, wherein the machine learning task includes a classifier, an object detector, a semantic segmentation, or speech recognition.

3. The computer-implemented method of claim 1, wherein the optimizer includes a stochastic gradient descent optimizer, adam optimizer, gradient descent optimizer, or an adaptive optimizer.

4. The computer-implemented method of claim 1, wherein the paired cleaned-perturbed data are sent to the robustifier in parallel.

5. The computer-implemented method of claim 1, wherein the first threshold includes an amount of loss of the input data.

6. The computer-implemented method of claim 1, wherein the perturbed data is generated utilizing a project gradient descent attack.

7. The computer-implemented method of claim 1, wherein the input data includes video information obtained from the camera.

8. A system including a machine-learning network, comprising:
an input interface configured to receive input data from a sensor, wherein the sensor includes a camera, a radar, a sonar, or a microphone;
a processor, in communication with the input interface, wherein the processor is programmed to:
receive the input data, wherein the input data is indicative of image, radar, sonar, or sound information;
generate an input data set utilizing the input data, wherein the input data set includes perturbed data;
send the input data set to a robustifier, wherein the robustifier is configured to clean the input data set by removing perturbations associated with the input data set to create a modified input data set;
send the modified input data set to a machine learning task;
train the robustifier utilizing the modified input data set to obtain a trained robustifier; and
output the trained robustifier and the machine learning task in response to convergence to a first threshold.

9. The system of claim 8, wherein the processor is further programmed to randomly sample a base classifier at each iteration.

10. The system of claim 8, wherein the input data set includes perturbed data, wherein the perturbed data is generated utilizing a project gradient descent attack.

11. The system of claim 8, wherein the perturbed data set is computer-generated data corresponding to a clean data set.

12. The system of claim 8, wherein the machine learning task is a deep neural network.

13. The system of 8, wherein the machine learning task includes a classifier, an object detector, a semantic segmentation, or speech recognition.

14. A computer-program product storing instructions which, when executed by a computer, cause the computer to:
receive an input data from a sensor, wherein the sensor includes a camera, a radar, a sonar, or a microphone;
generate an input data set utilizing the input data set, wherein the input data set includes perturbed data;
send the input data set to a robustifier, wherein the robustifier is configured to clean the input data set by removing perturbations associated with the input data set to create a modified input data set;
send the modified input data set to a pretrained machine learning task;
train the robustifier utilizing the modified input data set; and
output a trained robustifier upon convergence to a first threshold.

15. The computer-program product of claim 14, wherein the input data includes an image received from a camera in communication with the computer.

16. The computer-program product of claim 14, wherein the computer includes instructions that cause the computer to output the trained robustifier in response to a single forward pass.

17. The computer-program product of claim 14, wherein the machine learning task includes a classifier, an object detector, a semantic segmentation, or speech recognition.

18. The computer-program product of claim 14, wherein the input data set includes perturbed data, wherein the perturbed data is generated utilizing a project gradient descent attack.

19. The computer-program product of claim 14, wherein a weight associated with the machine learning task is fixed but parameters of the robustifier are changed.

20. The computer-program product of claim 14, wherein the input data includes sound information obtained from the microphone.
